(19) United States
(12) Patent Application Publication
(10) Pub. No.: US 2007/0098395 A1
(43) Pub. Date: May 3, 2007

(54) Digital camera user interface

(76) Inventors: Amy E. Battles, Windsor, CO (US); Shanshan Li, Fort Collins, CO (US); Norman C. Pyle, Greeley, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/262,565

(22) Filed: Oct. 31, 2005

(51) Int. Cl. G03B 17/00

(52) U.S. Cl. 396/299

(57) ABSTRACT

An exemplary user interface for a digital camera has a non linear configuration to provide a more ergonomic control function for a user of the camera. The interface may take the form of a touchpad and, in one exemplary embodiment, may be used to control camera zoom.

U.S. patent application Ser. No. ______, of Amy E. Battles (attorney docket no. 200506143-1), filed on the same day as this application, U.S. patent application Ser. No. ______, Amy E. Battles (attorney docket no. 200506124-1), filed on the same day as this application, U.S. patent application Ser. No. ______, of Amy E. Battles, Daniel J. Byrne, Shanshan Li and Norman C. Pyle (attorney docket no. 200506156-1) filed on the same day as this application, U.S. patent application Ser. No. ______, of Amy E. Battles (attorney docket no. 200506125-1) filed on the same day as this application and U.S. patent application Ser. No. ______, of Mark J. Bianchi, Norman C. Pyle, Amy E. Battles, Shanshan Li and Daniel J. Byrne, (attorney docket no. 200506123-1) filed on the same day as this application, are all hereby incorporated by reference for all that is disclosed therein.

### BACKGROUND

As handheld electronic devices continue to have more features, a more robust method of navigating the interface is needed. Some functions are “end-to-end” functions and, as such, do not map well to a continuous rotary control. One example of such an end-to-end function is zooming a lens on a digital camera. The camera lens has a maximum wide angle position and a maximum telephoto position, so it does not map well to a continuous rotary control. A linear control, however, is not particularly ergonomic.

### BRIEF DESCRIPTION OF THE DRAWINGS

FIG. 1 is a front perspective view of an exemplary digital camera.

FIG. 2 is an elevation view of a rear face of the exemplary digital camera of FIG. 1.

FIG. 3 is a detail view of a portion of the digital camera rear face of FIG. 2 showing an exemplary scroll strip.

FIG. 4 is a detail view of a portion of the digital camera rear face of FIG. 2 showing an alternative exemplary scroll strip.

FIG. 5 is a detail view of a portion of the digital camera rear face of FIG. 2 showing a further alternative exemplary scroll strip.

### DETAILED DESCRIPTION

An exemplary digital camera may include a housing having a front face and an oppositely-disposed rear face; a display formed on the rear face and a scroll strip formed on the rear face. The scroll strip is formed from a touchpad, has a non-linear configuration and is capable of controlling at least one function of the digital camera.

Also disclosed is an exemplary method including providing a digital camera having a housing including a front face and an oppositely-disposed rear face; a display formed on the rear face and a scroll strip formed on the rear face. The scroll strip is formed from a touch pad. A digit of the user (e.g., a finger or thumb) may be moved along the scroll strip in a non-linear motion to control at least one function of the digital camera.

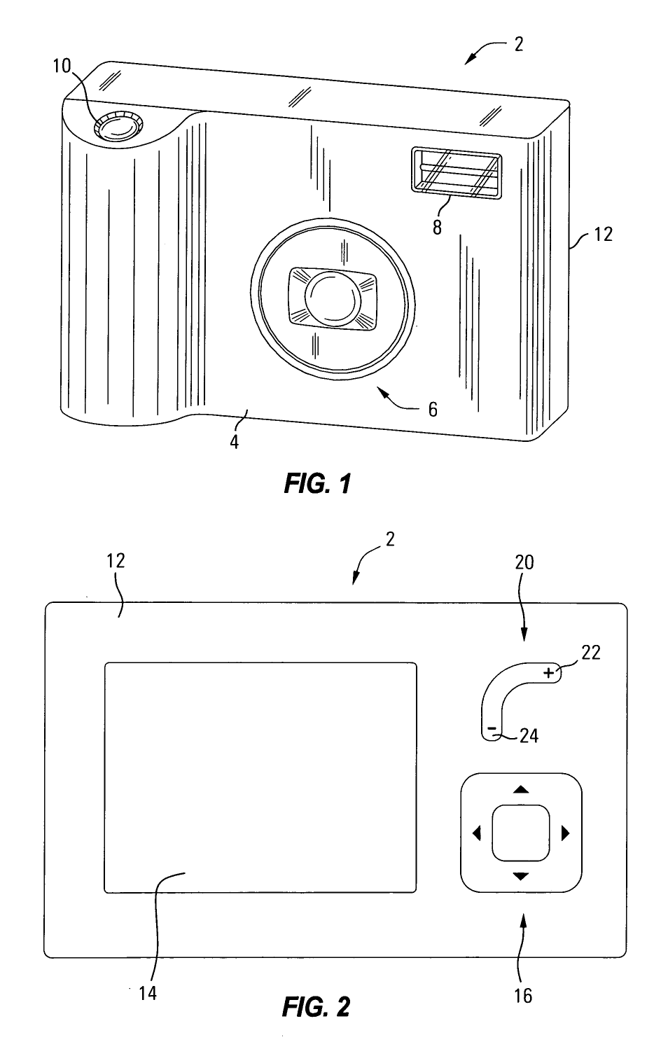

FIG. 1 illustrates an exemplary digital camera 2. The camera 2 may include a housing having a front face 4 and an oppositely disposed and generally parallel rear face 12. The digital camera 2 may include various devices related to the operation of the camera and features to facilitate user interface with the camera as will be readily understood by one skilled in the art. The camera 2 may, for example, include a lens assembly 6, a flash unit 8, and a shutter release button 10, as shown in FIG. 1.

FIG. 2 illustrates the rear face 12 of the digital camera 2 in further detail. With reference to FIG. 2, a display 14 which may, for example, be a conventional LCD-type display and a button assembly 16 may be located on the rear face 12. Button assembly 16 may be provided for user input in a conventional manner. The rear face 12 may further include a scroll strip 20 which may, for example, be provided to control the zooming function of the camera as will be discussed in further detail herein.

It is noted that, although some features of the digital camera 2 have been described above, the camera will include other devices, not described or shown herein, related to the operation of the camera as will be readily understood by one skilled in the art. The camera may, for example, include an image capturing device (e.g., a CCD), a processor and other buttons and/or switches to facilitate user interface in a conventional manner.

With reference again to FIG. 2, it can be seen that the scroll strip 20 may be formed having an arch shape to facilitate ergonomic engagement for thumb of a user of the camera 2. Specifically, the arch shape corresponds to the natural motion of a user's thumb when the user is holding the camera.

The scroll strip may be formed as a conventional touchpad that is capable of sensing directional motion (e.g., a thumb sliding along the touchpad) and contact (e.g., tapping in a specific location along the touchpad). The touchpad may be located behind the rear face 12 of the camera 2. The rear face 12 may include an opening therein in the shape of an arch, as indicated. It is noted that, although the term “opening” is used herein, the opening in the rear face 12 may alternatively be covered with a material that effectively seals the camera housing but still allows the touchpad to sense a touch or press.

To use the scroll strip 20 to zoom the camera, a user may slide a thumb or finger along the scroll strip 20. Sliding the thumb or finger to the right, as viewed in FIG. 2, for example, causes the camera 2 to zoom in while sliding to the left and down causes the camera to zoom out. The scroll strip may include icons thereon indicative of the zoom in and zoom out functions described above. The scroll strip 20 may, for example, include an icon 22 formed as a plus sign and an icon 24 formed as a minus sign.

The user may also tap or press a specific area on the scroll strip 20 to cause the camera to “snap” to a particular zoom setting dictated by the location along the scroll strip that is tapped or pressed. Tapping the center of the scroll strip, for example, may cause the camera 2 to snap to a zoom position midway between its maximum and minimum zoom. Tapping a location 30% of the way from the left edge of the scroll strip to the right edge may cause the camera to snap to a zoom position equal to 30% of its maximum zoom, and so on.

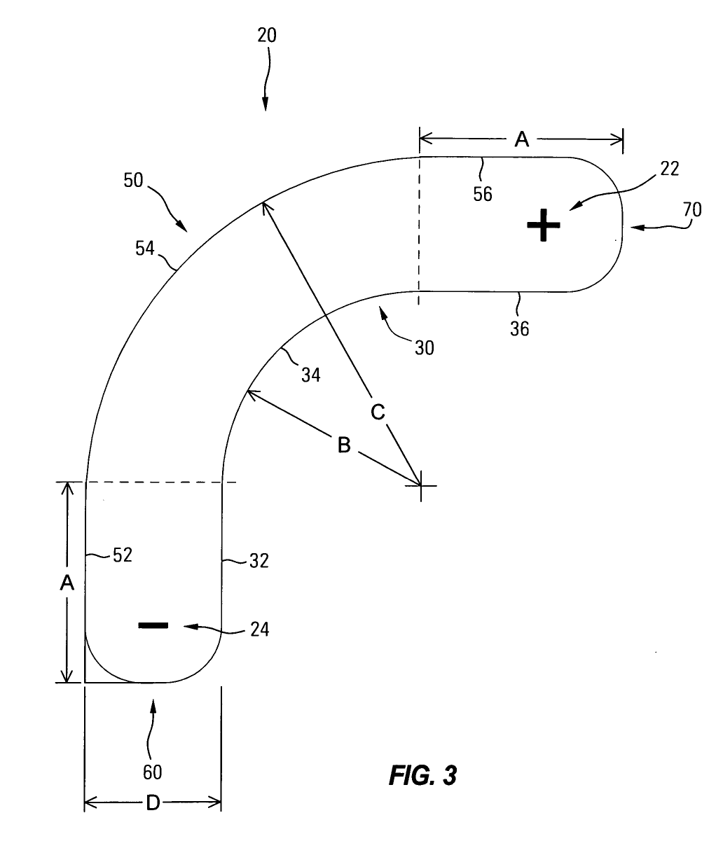

FIG. 3 illustrates the scroll strip 20 in further detail. As can be seen, scroll strip 20 may have an inner edge 30 and an oppositely disposed outer edge 50. Inner edge 30 may include a contiguous first straight portion 32, curved portion 34 and second straight portion 36, as shown. First straight portion 32 and second straight portion 36 may each have a length “A”, for example, of about 10 mm. Curved portion 34 may have a radius “B”, for example, of about 8 mm. Outer edge 50 may include a contiguous first straight portion 52, curved portion 54 and second straight portion 56, as shown. First straight portion 52 and second straight portion 56 may each extend for the length “A”, previously discussed. Curved portion 54 may have a radius “C”, for example, of about 14 mm. A first end edge 60 connects the first straight portion 32 of the inner edge 30 with the first straight portion 52 of the outer edge 50. A second end edge 70 connects the second straight portion 36 of the inner edge 30 with the second straight portion 56 of the outer edge 50. Scroll strip 20 may have a substantially consistent width “D” extending between the inner edge 30 and outer edge 50. The width “D” may, for example, be about 6 mm.

By providing an arch-shaped scroll strip on a camera, the user can move back and forth along the arch in a comfortable movement to zoom the lens.

As an alternative to the configuration shown in FIG. 3, the scroll strip 20 could be formed as a “pure” arch, in other words, an arch omitting the straight portions 32, 52 and 36, 56 as described above. In such an alternative embodiment, the arch may be extended to cover 120 degrees of arc (rather than the 90 degrees of arc shown in FIG. 3).

As a further alternative, the scroll strip 20 could be rotated to a different orientation than that shown in FIGS. 2 and 3. The scroll strip 20 may, for example, be rotated 45 degrees in a clockwise direction from the orientation illustrated in FIGS. 2 and 3. As can be appreciated, this rotation would result in the curved portion 54 being the uppermost portion of the strip 20. The user, thus, would be able to associate the highest portion of the scroll strip 20 with the center scrolling position.

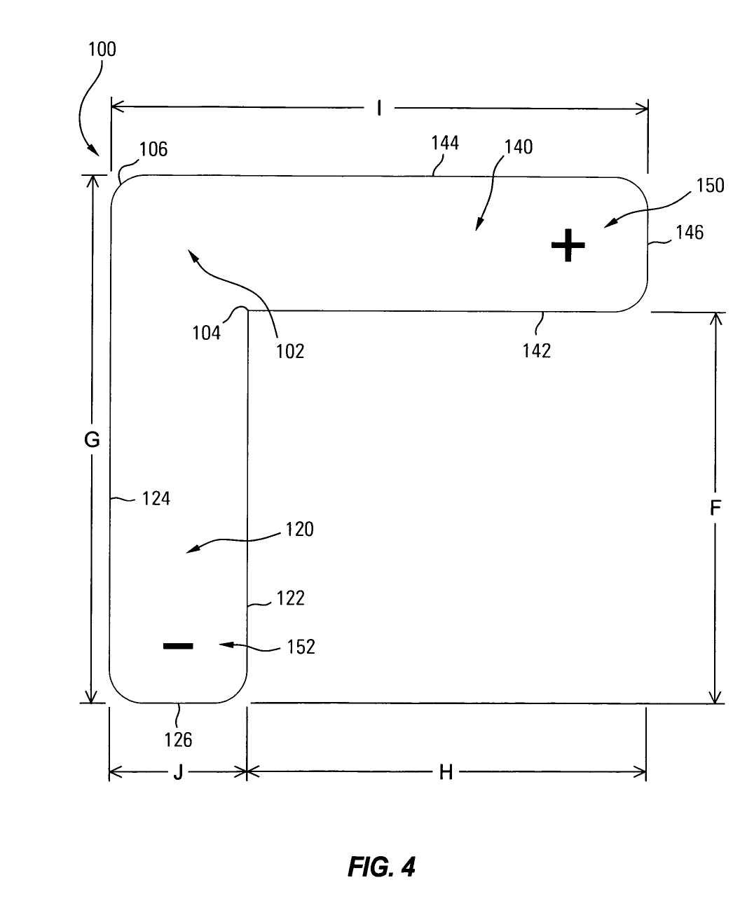

FIG. 4 illustrates an alternative exemplary scroll strip 100. Scroll strip 100 may be formed from a conventional touchpad in the same manner as described above with respect to the arch-shaped embodiment shown in FIGS. 2 and 3. The scroll strip 100 may also be located in generally the same area of the camera rear face 12 as the previously-described scroll strip 20 (FIG. 2). With reference to FIG. 4, the scroll strip 100 may generally be formed having an “L” shape. The L-shaped scroll strip 100 provides tactile feedback to the user. Specifically, the user is able feel when his or her thumb or finger reaches the “joint” of the “L”, i.e., a location indicated generally by the reference numeral 102 in FIG. 4. Since this is the middle of the scroll strip 100, this allows the user to quickly and confidently locate the middle zoom position of the camera without the need to look at the camera. In other words, the user can keep his or her eyes on the subject being photographed while quickly locating and activating the middle zoom position. In summary, the L-shaped scroll strip 100 has the advantage of providing tactile feedback to the user indicating the center of the zoom range while still providing a relatively ergonomic configuration.

With further reference to FIG. 4, the scroll strip 100 may generally include a first leg portion 120 and a second perpendicular leg portion 140. First leg portion 120 may have an inner edge 122 and an oppositely disposed outer edge 124. Second leg portion 140 may also have an inner edge 142 and an outer edge 144. The first leg portion inner edge 122 meets the second leg portion inner edge 142 at a junction 104. The first leg portion outer edge 124 meets the second leg portion outer edge 144 at a junction 106. First leg portion inner edge 122 may have a length “F”, for example, of about 12 mm. First leg portion outer edge 124 may have a length “G”, for example, of about 18 mm. Second leg portion inner edge 142 may have a length “H”, for example, of about 12 mm. Second leg portion outer edge 144 may have a length “I”, for example, of about 18 mm. A first leg portion edge 126 connects the first leg portion inner and outer edges 122, 124, as shown. A second leg portion edge 146 connects the second leg portion inner and outer edges 142, 144, as shown. The scroll strip 100 may have a substantially consistent width “J” extending between the first leg portion inner and outer edges 122, 124 and between the second leg portion inner and outer edges 142, 144. The width “J” may, for example, be about 6 mm. The scroll strip 100 may, for example, include an icon 150 formed as a plus sign and an icon 152 formed as a minus sign.

As an alternative to the configuration shown in FIG. 4, the scroll strip 100 could be rotated to a different orientation than that shown in FIG. 4. The scroll strip 100 may, for example, be rotated 45 degrees in a clockwise direction from the orientation illustrated in FIG. 4. As can be appreciated, this rotation would result in the joint 102 being the uppermost portion of the strip 100. This would provide further feedback to the user, indicating the middle position of the scrolling range.

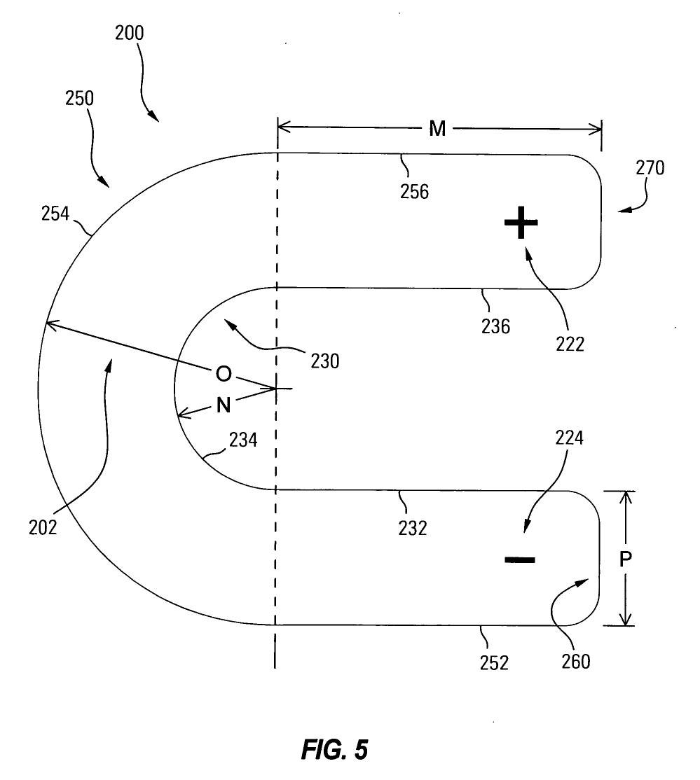

FIG. 5 illustrates an alternative exemplary scroll strip 200. Scroll strip 200 may be formed from a conventional touchpad in the same manner as described above with respect to the arch-shaped embodiment shown in FIGS. 2 and 3. The scroll strip 200 may also be located in generally the same area of the camera rear face 12 as the previously-described scroll strip 20 (FIG. 2). With reference to FIG. 5, the scroll strip 100 may generally be formed having a “U” shape. In a manner similar to the L-shaped scroll strip 100 described above, the U-shaped scroll strip 200 provides tactile feedback to the user. Specifically, the user is able to feel when his or her thumb or finger reaches the curved portion of the “U”, i.e., a location indicated generally by the reference numeral 202 in FIG. 5. Since this is the middle of the scroll strip 200, this allows the user to quickly and confidently locate the middle zoom position of the camera without the need to look at the camera in a manner similar to the L shaped scroll pad 100 previously described. In summary, the U-shaped scroll strip 200 has the advantage of providing tactile feedback to the user indicating the center of the zoom range while still providing a relatively ergonomic configuration.

With further reference to FIG. 5, the scroll strip 200 may have an inner edge 230 and an oppositely disposed outer edge 250. Inner edge 230 may include a contiguous first straight portion 232, curved portion 234 and second straight portion 236, as shown. First straight portion 232 and second straight portion 236 may each have a length “M”, for example, of about 10 mm. Curved portion 234 may have a radius “N”, for example, of about 8 mm. Outer edge 250 may include a contiguous first straight portion 252, curved portion 254 and second straight portion 256, as shown. First straight portion 252 and second straight portion 256 may each extend for the length “M”, previously discussed. Curved portion 254 may have a radius “O”, for example, of about 14 mm. A first end edge 260 connects the first straight portion 232 of the inner edge 230 with the first straight portion 252 of the outer edge 250. A second end edge 270 connects the second straight portion 236 of the inner edge 230 with the second straight portion 256 of the outer edge 250. Scroll strip 200 may have a substantially consistent width “P” extending between the inner edge 30 and outer edge 50. The width “P” may, for example, be about 6 mm. The scroll strip 200 may, for example, include an icon 222 formed as a plus sign and an icon 224 formed as a minus sign.

As an alternative to the configuration shown in FIG. 5, the scroll strip 200 could be rotated to a different orientation than that shown in FIG. 5. The scroll strip 200 may, for example, be rotated 90 degrees in a clockwise direction from the orientation illustrated in FIG. 5. As can be appreciated, this rotation would result in the curved portion 202 being the uppermost portion of the strip 200. This would provide further feedback to the user, indicating the middle position of the scrolling range.

It is noted that the scroll strips 20, 100 and 200 have been described herein for controlling zooming for exemplary descriptive purposes only. The scroll strips may also be alternatively or additionally used for other functions, e.g., exposure control, focus control or panning.

While illustrative and presently preferred embodiments of the invention have been described in detail herein, it is to be understood that the inventive concepts may be otherwise variously embodied and employed and that the appended claims are intended to be construed to include such variations except insofar as limited by the prior art.

What is claimed is:

1. A digital camera comprising:
a housing comprising a front face and an oppositely-disposed rear face;
a display formed on said rear face;
a scroll strip formed on said rear face, said scroll strip capable of controlling at least one function of said digital camera;
said scroll strip having a non-linear configuration;
said scroll strip being formed from a touchpad.

2. The digital camera of claim 1, and further wherein:
said scroll strip has an arch shaped configuration.

3. The digital camera of claim 1, and further wherein:
said scroll strip has an “L” shaped configuration.

4. The digital camera of claim 1, and further wherein:
said scroll strip has a “U” shaped configuration.

5. The digital camera of claim 1, and further wherein:
said scroll strip is used to control zooming of a lens of said digital camera.

6. A method comprising:
providing a digital camera comprising:
a housing including a front face and an oppositely-disposed rear face;
a display formed on said rear face;
a scroll strip formed on said rear face, said scroll strip comprising a touch pad;
moving a digit along said scroll strip in a non-linear motion to control at least one function of said digital camera.

7. The method of claim 6, and further wherein:
said scroll strip has an arch shaped configuration.

8. The method of claim 6, and further wherein:
said scroll strip has an “L” shaped configuration.

9. The method of claim 6, and further wherein:
said scroll strip has a “U” shaped configuration.

10. The method of claim 6, and further wherein:
said at least one function is a zooming function.
